(19) United States
(12) Patent Application Publication
(10) Pub. No.: US 2023/0185294 A1
(43) Pub. Date: Jun. 15, 2023

(54) ENERGY STORAGE DEVICE, SYSTEM FOR SYNCHRONIZING HISTORICAL USAGE DATA OF ENERGY STORAGE DEVICES AND ELECTRONIC SYSTEM

(71) Applicant: Gogoro Inc., Hong Kong (CN)

(72) Inventors: Liang-Yi Hsu, Taoyuan City (TW); I-Sheng Chen, Taoyuan City (TW); Yong-Sheng Chen, Taoyuan City (TW); Wei-Tsung Huang, Taoyuan City (TW)

(21) Appl. No.: 18/065,900

(22) Filed: Dec. 14, 2022

Related U.S. Application Data
(60) Provisional application No. 63/290,014, filed on Dec. 15, 2021.

(51) Int. Cl. G05B 23/02; G05B 15/02; H02J 13/00

(52) U.S. Cl. CPC G05B 23/024; G05B 15/02; H02J 13/00002; G05B 2223/04

(57) ABSTRACT

An energy storage device includes a sensor, a communication circuit and a processor. The sensor is configured to detect an abnormal event occurred in the energy storage device. The communication circuit is configured to connect to a local area network. The local area network includes a plurality of nodes formed by the energy storage device and other energy storage devices. The processor is configured to generate, according to the abnormal event detected by the sensor, historical usage data recording the abnormal event. In response to a trigger event, the processor is further configured to: update the historical usage data; and control the communication circuit to transmit at least part of the updated historical usage data to at least one energy storage device adjacent to the energy storage device in the local area network.

### RELATED APPLICATIONS

This application claims priority to U.S. Provisional Application Ser. No. 63/290,014, filed Dec. 15, 2021, which is herein incorporated by reference in its entirety.

### BACKGROUND

### Technical Field

The present disclosure relates to a data synchronization technique of energy storage devices. More particularly, the present disclosure relates to an energy storage device, a system for synchronizing historical usage data of energy storage devices and an electronic system.

### Description of Related Art

It is a trend in today's society to use the automotive battery as the power source to drive the vehicle. Electric vehicles currently on the market are generally equipped with swappable batteries. For system administrators who provide battery swap services, swappable batteries are easier to charge and maintain. In order to facilitate the system administrator to determine the appropriate maintenance and repair details, it is necessary to record the historical usage data of the batteries.

However, when the system administrator has to manage a large number of batteries at the same time, how to effectively manage these batteries is a problem that the system administrator must face. For example, the system administrator may need to read these batteries one by one to obtain the historical usage data stored in each battery. Such an approach cannot efficiently obtain a large amount of historical usage data. In addition, during the long-term use, the battery may encounter suddenly damage which causes the battery fail to feedback the historical usage data. Therefore, how to back up the historical usage data of each battery as possible is a problem to be solved in the industry.

### SUMMARY

The disclosure provides a system for synchronizing historical usage data of energy storage devices. The system includes a plurality of energy storage devices configured to form a plurality of nodes of a local area network by a wireless communication technique. Each energy storage device is configured to generate the historical usage data according to an abnormal event occurred in the energy storage device, so as to use the historical usage data to record the abnormal event. The plurality of nodes include a root node. The root node is configured to control each of the others of the plurality of nodes to update, according to the historical usage data updated by the root node, the historical usage data of each of the others of the plurality of nodes.

In some embodiments, the plurality of nodes include at least one first level node. A first level node of the at least one first level node is connected to the root node. In response to detecting, by the root node, a new abnormal event of the root node, the root node is configured to update the historical usage data of the root node according to the new abnormal event of the root node, and configured to transmit at least part of the historical usage data updated by the root node to the first level node, in order to control the first level node to update the historical usage data of the first level node. In response to receiving, by the root node, the historical usage data of the first level node, the root node is configured to update, according to the historical usage data of the first level node, the historical usage data of the root node, and configured to transmit the at least part of the historical usage data updated by the root node to the first level node, in order to control the first level node to update the historical usage data of the first level node.

In some embodiments, the plurality of nodes further include at least one second level node, and the first level node is connected between the root node and a second level node of the at least one second level node. In response to detecting, by the first level node, a new abnormal event of the first level node, the first level node is configured to update the historical usage data of the first level node according to the new abnormal event of the first level node, and configured to transmit at least part of the historical usage data updated by the first level node to the root node. In response to receiving, by the first level node, the at least part of the historical usage data updated by the root node, the first level node is configured to update the historical usage data of the first level node according to the at least part of the historical usage data updated by the root node, and configured to transmit the at least part of the historical usage data updated by the first level node to the second level node. In response to receiving, by the first level node, the historical usage data of the second level node, the first level node is configured to update the historical usage data of the first level node according to the historical usage data of the second level node, and configured to transmit the at least part of the historical usage data updated by the first level node to the root node.

In some embodiments, in response to detecting, by the second level node, a new abnormal event of the second level node, the second level node is configured to update the historical usage data of the second level node according to the new abnormal event of the second level node. The second level node is further configured to transmit at least part of the historical usage data updated by the second level node to the first level node.

In some embodiments, the plurality of nodes periodically transmit at least part of respective historical usage data to respective connected corresponding nodes, in order to back up the respective historical usage data.

In some embodiments, the root node is further configured to determine a maximum number of nodes of the local area network.

The disclosure provides an energy storage device including a sensor, a communication circuit and a processor. The sensor is configured to detect an abnormal event occurred in the energy storage device. The communication circuit is configured to connect to a local area network. The local area network includes a plurality of nodes formed by the energy storage device and other energy storage devices. The processor is configured to generate, according to the abnormal event detected by the sensor, historical usage data recording the abnormal event. In response to a trigger event, the processor is further configured to: update the historical usage data; and control the communication circuit to transmit at least part of the historical usage data updated by the energy storage device to at least one energy storage device adjacent to the energy storage device in the local area network.

In some embodiments, the energy storage device is a root node of the local area network. In response to the trigger event that a new abnormal event occurred in the energy storage device is detected by the sensor, the processor is further configured to update the historical usage data of the energy storage device according to the new abnormal event, and configured to control the communication circuit to transmit the at least part of the historical usage data updated by the energy storage device to all child node(s) of the energy storage device. In response to the trigger event that another historical usage data is received from the local area network by the communication circuit, the processor is further configured to update the historical usage data of the energy storage device according to the another historical usage data, and configured to control the communication circuit to transmit the at least part of the historical usage data updated by the energy storage device to all child node(s) of the energy storage device.

In some embodiments, the processor is further configured to determine a maximum number of nodes of the local area network.

In some embodiments, the energy storage device is a first level node of the local area network connected between a root node and a second level node. In response to the trigger event that historical usage data of one of the root node and the second level node is received by the communication circuit, the processor is configured to update the historical usage data of the energy storage device according to the historical usage data of the one of the root node and the second level node, and configured to control the communication circuit to transmit the at least part of the historical usage data updated by the energy storage device to another one of the root node and the second level node.

In some embodiments, the energy storage device is a first level node of the local area network connected between a root node and a second level node. In response to the trigger event that a new abnormal event occurred in the energy storage device is detected by the sensor, the processor is further configured to update the historical usage data of the energy storage device according to the new abnormal event, and configured to control the communication circuit to transmit the historical usage data updated by the energy storage device to the root node.

In some embodiments, the processor is further configured to control the communication circuit to periodically transmit at least part of the historical usage data of the energy storage device to the at least one energy storage device adjacent to the energy storage device.

The disclosure provides an electronic system including a load device and an energy storage device. The load device includes a communication circuit configured to connect to a local area network. The local area network includes a plurality of nodes formed by the electronic system and other electronic systems. The energy storage device is configured to provide electricity to the load device, and includes a sensor and a processor. The sensor is configured to detect an abnormal event occurred in the energy storage device. The processor is configured to generate, according to the abnormal event detect by the sensor, historical usage data recording the abnormal event. In response to a trigger event, the processor is further configured to: update the historical usage data; and trigger the communication circuit to transmit at least part of the historical usage data updated by the energy storage device to at least one electronic system adjacent to the electronic system in the local area network.

In some embodiments, the electronic system is a root node of the local area network. In response to the trigger event that a new abnormal event occurred in the energy storage device is detected by the sensor, the processor is further configured to update the historical usage data of the energy storage device according to the new abnormal event, and configured to trigger the communication circuit to transmit the at least part of the historical usage data updated by the energy storage device to all child node(s) of the electronic system. In response to the trigger event that another historical usage data is received from the local area network by the communication circuit, the processor is further configured to update the historical usage data of the energy storage device according to the another historical usage data, and configured to trigger the communication circuit to transmit the at least part of the historical usage data updated by the energy storage device to all child node(s) of the electronic system.

In some embodiments, the processor is further configured to determine a maximum number of nodes of the local area network.

In some embodiments, the electronic system is a first level node of the local area network connected between a root node and a second level node. In response to the trigger event that historical usage data of one of the root node and the second level node is received by the communication circuit, the processor is configured to update the historical usage data of the energy storage device according to the historical usage data of the one of the root node and the second level node, and configured to trigger the communication circuit to transmit the at least part of the historical usage data updated by the energy storage device to another one of the root node and the second level node.

In some embodiments, the electronic system is a first level node of the local area network connected between a root node and a second level node. In response to the trigger event that a new abnormal event occurred in the energy storage device is detected by the sensor, the processor is further configured to update the historical usage data of the energy storage device according to the new abnormal event, and configured to trigger the communication circuit to transmit the historical usage data updated by the energy storage device to the root node.

In some embodiments, the processor is further configured to trigger the communication circuit to periodically transmit at least part of the historical usage data of the energy storage device to the at least one electronic system adjacent to the electronic system.

One of the advantages of the above energy storage device, system for synchronizing historical usage data of energy storage devices and electronic system is that the historical usage data can be effectively retrieved, and another advantage is that the historical usage data of each energy storage device has backup in the system for synchronizing historical usage data of energy storage devices.

It is to be understood that both the foregoing general description and the following detailed description are by examples, and are intended to provide further explanation of the disclosure as claimed.

### BRIEF DESCRIPTION OF THE DRAWINGS

FIG. 1 is a simplified functional block diagram of an energy storage device according to one embodiment of the present disclosure.

FIG. 2 is a schematic diagram of a system for synchronizing historical usage data of energy storage devices, according to one embodiment of the present disclosure.

FIG. 3 is a flowchart for illustrating the process of connecting to a local area network.

FIG. 4 is a flowchart of a method for synchronizing the historical usage data, according to one embodiment of the present disclosure.

FIG. 5 is a flowchart of a method for synchronizing the historical usage data, according to one embodiment of the present disclosure.

FIG. 6 is a flowchart of a method for synchronizing the historical usage data, according to one embodiment of the present disclosure.

FIG. 7 is a simplified functional block diagram of an electronic system according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

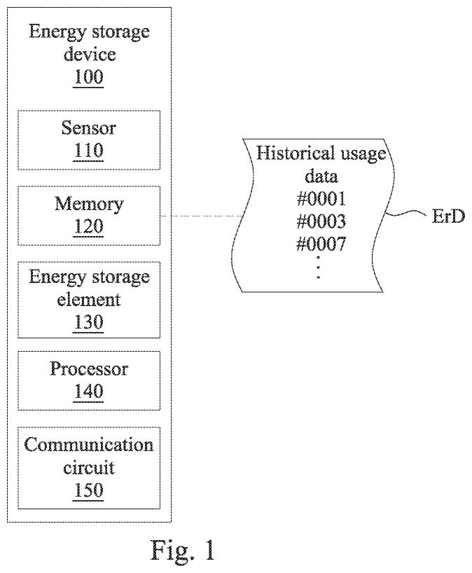

FIG. 1 is a simplified functional block diagram of an energy storage device 100 according to one embodiment of the present disclosure. The energy storage device 100 comprises a sensor 110, a memory 120, an energy storage element 130, a processor 140 and a communication circuit 150. In some embodiments, the energy storage device 100 is a mobile battery that can be charge and discharge for multiple times. The user may use the energy storage device 100 to provide electricity to various suitable load devices. The load device is discussed in detail in the later paragraphs.

The sensor 110 is configured to detect an abnormal event occurred in the energy storage device 100. In some embodiments, the abnormal event may be an excessive high or low current or voltage during charging or discharging of the energy storage device 100, an excessive high or low temperature of any one of the functional blocks of the energy storage device 100, an excessive high or low environmental temperature, excessive high acceleration (representing that the energy storage device 100 possibly encounters an impact), etc. The said “excessive high” may represent that the value is higher than a corresponding threshold stored in the memory 120. The said “excessive low” may represent that the value is lower than another corresponding threshold stored in the memory 120. In some embodiments, the sensor 110 comprises voltmeter, ammeter, gyroscope, accelerometer or any combination thereof.

The memory 120 is configured to store firmware and/or software formed by computer-readable instructions. In some embodiments, the memory 120 comprises a non-volatile memory, a volatile memory, other suitable storage element or any combination thereof.

The energy storage element 130 comprises, but is not limited to, a battery pack array or a supercapacitor array. The battery pack array is, for example, one or more chemical batteries (including but not limited to: Nickel-Cadmium battery pack battery or Lithium-ion battery pack). The present disclosure does not limit the structure and the composition of the energy storage element 130, and the energy storage element 130 may be implemented through other suitable means.

The processor 140 is configured to load and execute the said computer-readable instructions, so as to control the sensor 110, the memory 120, the energy storage element 130 and the communication circuit 150. When the sensor 110 detects the abnormal event, the processor 140 adds a corresponding error code to the historical usage data ErD according to type of the abnormal event, in which the historical usage data ErD may be stored in the memory 120. For example, the error code “#0001” represents the excessive high voltage during discharging; the error code “#0003” represents the excessive high environmental temperature; the error code “#0007” represents the excessive high acceleration, etc. Accordingly, the processor 140 uses the abnormal event detected by the sensor 110 as a trigger event, and generates, in response to the trigger event, the historical usage data ErD recording the abnormal event.

In some embodiments, the processor 140 is, for example, a micro-processor, a micro-controller, a programmable logic controller (PLC), single-chip or multi-chip general processor, a digital signal processor (DSP), an application specific integrated circuit (ASIC), a field programmable gate array (FPGA), the controller that can receive signal from various sensors, execute logical operations and transmit signals to various components or any combination thereof.

The communication circuit 150 is configured to establish a wireless connection with the communication circuit 150 of another near energy storage device 100. In some embodiments, the communication circuit 150 supports Bluetooth, Wi-Fi, other suitable wireless communication protocols or any combination thereof.

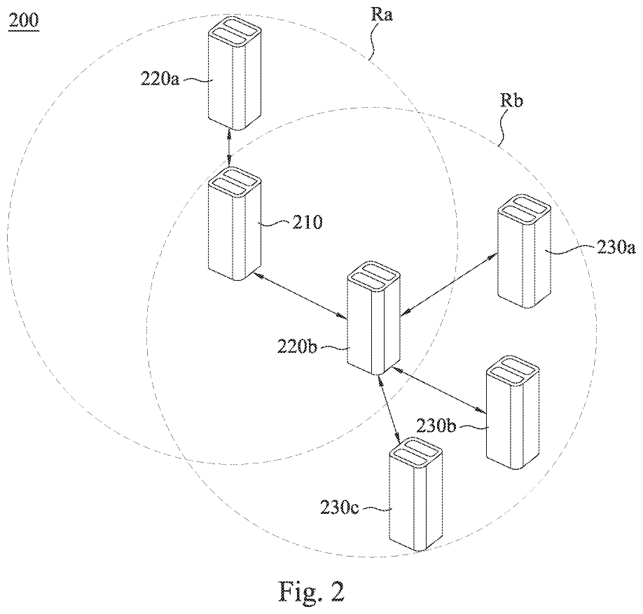

FIG. 2 is a schematic diagram of a system 200 for synchronizing historical usage data of energy storage devices, according to one embodiment of the present disclosure. The system 200 comprises a plurality of energy storage devices 210, 220a-220b and 230a-230c that are near to each other. The energy storage devices 210, 220a-220b and 230a-230c may form a local area network through the wireless communication technique, and operate as a plurality of nodes of the local area network, respectively. Each energy storage device of FIG. 2 may be implemented by the energy storage device 100 of FIG. 1. In some embodiments, the energy storage devices 210, 220a-220b and 230a-230c synchronize the respective historical usage data ErD through the local area network.

The energy storage device 210 is a root node, that is, a 0-th level node. In some embodiments, the root node does not have any parent node, but may have or not have one or more child nodes (e.g., the energy storage devices 220a-220b). The energy storage devices 220a-220b are first level nodes. Each first level node has a parent node (e.g., the energy storage device 210), and may have or not have one or more child nodes (e.g., the energy storage devices 230a-230c). The energy storage devices 230a-230c are second level nodes. Each second level node has a parent node (e.g., the energy storage device 220b), and may have no child node.

The energy storage device 210 (i.e., the root node) is the one established the local area network. For example, when the energy storage device 210 is connected to the load device, the energy storage device 210 may scan, through the communication circuit 150, and determine whether a connectable local area network already exists in a communication range Ra of the energy storage device 210. If not, the energy storage device 210 may configure itself as the root node of the local area network, and may allow other energy storage devices to connect with the energy storage device 210 to join the local area network. Additionally, a radius of the communication range Ra may be set to several meters to several tens of meters, the present disclosure does not limit the size of the communication range Ra.

In some embodiments, the energy storage device 210 (i.e., the root node) is configured to determine a maximum number of nodes of the local area network. When the energy storage device 210 determines that the maximum number of nodes of the local area network is M, the energy storage device 210 allows up to M energy storage devices (including the energy storage device 210 itself) to connect to the local area network to form the system 200, in which M is a positive integer (e.g., 32). When the energy storage device 210 determines that the number of the energy storage device(s) that have joined the local area network reaches the maximum number of nodes, the energy storage device 210 refuses a new energy storage device to join the local area network.

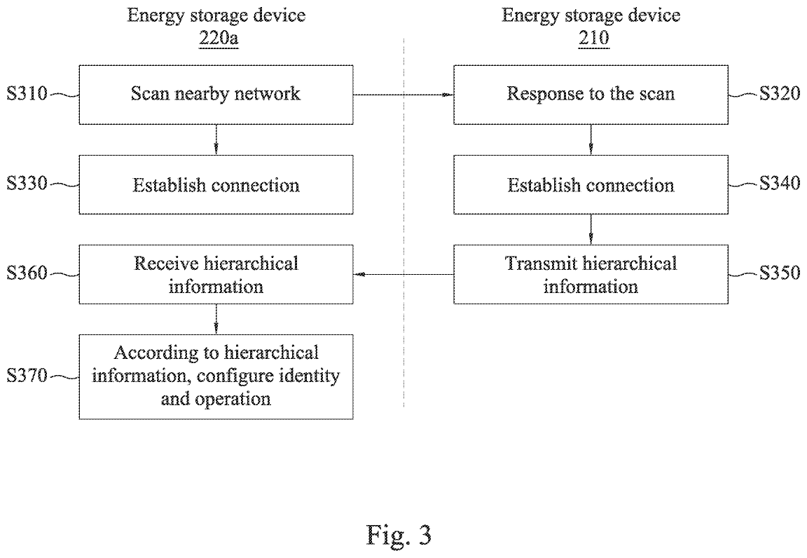

FIG. 3 is a flowchart for illustrating the process of connecting to the local area network. Operations S310, S330, S360 and S370 of FIG. 3 are performed by the energy storage device intended to connect to the local area network (e.g., the energy storage device 220a). Other operations S320, S340 and S350 are performed by the energy storage device that is already connected to the local area network (e.g., the energy storage device 210). Reference is made to FIG. 2 and FIG. 3. When the energy storage device 220a is connected to the load device within the communication range Ra of the energy storage device 210, the energy storage device 220a may perform operation S310 to scan whether a connectable local area network exists in the communication range thereof. The energy storage device 210 may perform operation S320 to response to the scan. The communication range of the energy storage device 220a is not depicted in FIG. 2, for the sake of brevity.

In one embodiment, the energy storage devices 210 and 220a are connected to each other through Bluetooth Low Energy (BLE) technique, but this disclosure is not limited thereto. In operation S310, the energy storage device 220a periodically enters a broadcasting state. When the energy storage device 220a enters the broadcasting state and the energy storage device 210 enters a scanning state, the energy storage device 210 performs operation S320 to transmit a connection signal to the energy storage device 220a to response to broadcasting packets sent by the energy storage device 220a. For example, the connection signal comprises identification information of the energy storage device 210, a number of vacancies of the local area network and information of whether to allow the energy storage device 220a to join the local area network. In some embodiments, as long as the number of the energy storage devices in the local area network does not reach an upper limit value, the energy storage device 210 remains in the scanning state.

Then, the energy storage devices 210 and 220a may perform operations S330 and S340 to establish the wireless connection. In operation S350, the energy storage device 210 transmits hierarchical information of the local area network, such as type or level of the node that the energy storage device 210 represents. The energy storage device 220a performs operation S360 to receive the hierarchical information, and proceeds to operation S370 to configure an identity (i.e., the type or level of the node that the energy storage device 220a represents) and operations thereof according to the hierarchical information. For example, the energy storage device 220a may realize, through the hierarchical information, that itself is connected to the root node, and therefore the energy storage device 220a configures itself as the first level node.

The energy storage devices 210 and 220b may connect to each other through similar steps, and therefore the detailed descriptions thereof are omitted here. Additionally, the steps of FIG. 3 are also applicable to the second level node that intends to join the local area network. For example, when the energy storage devices 230a-230c are connected to the load device within the communication range Rb of the energy storage device 220b, the energy storage devices 230a-230c may perform operations S310, S330, S360 and S370; and the energy storage device 220b may perform operations S320, S340 and S350, so as to establish wireless connections between the energy storage device 220b and the energy storage devices 230a-230c. As such, the energy storage devices 230a-230c external to the communication range Ra of the energy storage device 210 may, through the energy storage device 220b, indirectly communicate with the energy storage device 210 and join the local area network.

In some embodiments, when the local area network comprises only the root node and the first level nodes, the local area network form a star topology. In other embodiments, when the local area network comprises the root node, the first level nodes and the second level nodes, the local area network form a tree topology.

In some embodiments, the energy storage device 210, 220a-220b and 230a-230c of the local area network have firmware of the same version. The root node and the first level node may refuse the energy storage device having the firmware of different version to connect to the local area network.

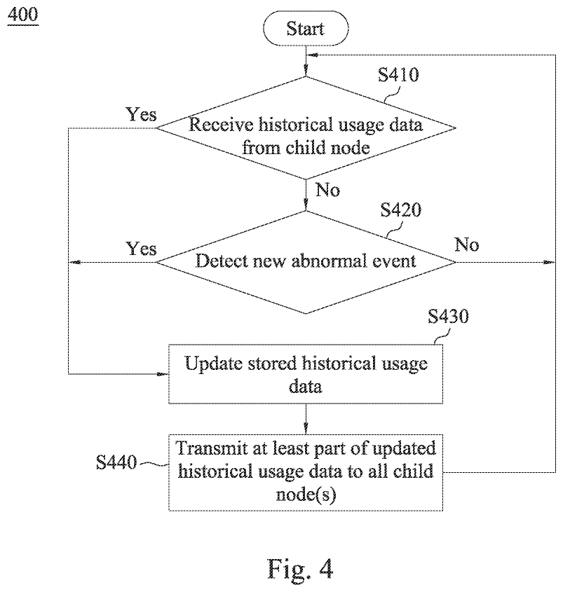

The root node (i.e., the energy storage device 210) may manage synchronization of the historical usage data ErD of all energy storage devices in the local area network. In the following paragraphs, the operations performed by the root node, the first level node and the second level node during the synchronization of the historical usage data ErD are discussed with reference to FIGS. 4-6.

FIG. 4 is a flowchart of a method 400 for synchronizing the historical usage data ErD, according to one embodiment of the present disclosure. When the processor 140 of the energy storage device 210 (i.e., the root node) executes the computer-readable instructions stored in the memory 120, the processor 140 may perform the method 400. In operation S410, the processor 140 determines whether the historical usage data ErD is received from the child node (i.e., the first level node) through the communication circuit 150. If the determination of operation S410 is “NO,” the processor 140 then performs operation S420 to determine whether the sensor 110 detects a new abnormal event. If the determination of operation S420 is also “NO,” the processor 140 may repeat operation S410.

On the other hand, when the determination of operation S410 is “YES,” the processor 140 may perform operation S430, that is, when the processor 140 receives, through the communication circuit 150, the historical usage data ErD from other nodes, the processor 140 use this as a trigger event. In response to such trigger event, the processor 140 updates the historical usage data ErD in the memory 120 (hereinafter referred to as “stored historical usage data ErD”), according to the historical usage data ErD from the child node. For example, the processor 140 may compare the historical usage data ErD from the child node with the stored historical usage data ErD, so as to use the error code(s) in the historical usage data ErD from the child node that are different from that of the stored historical usage data ErD as the new error code(s) and add to the stored historical usage data ErD. The said “compare” may be examining generation time, value and source of an error code in the historical usage data ErD from the child node, in which the “source” may be the energy storage device that originally generates such error code. If combination of the generation time, value and source of such error code is not found in the stored historical usage data ErD, the processor 140 may use such error code as the new error code and add to the stored historical usage data ErD.

In addition, when the determination of operation S420 is “YES,” the processor 140 also performs operation S430, in order to add the error code corresponding to the new abnormal event to the stored historical usage data ErD.

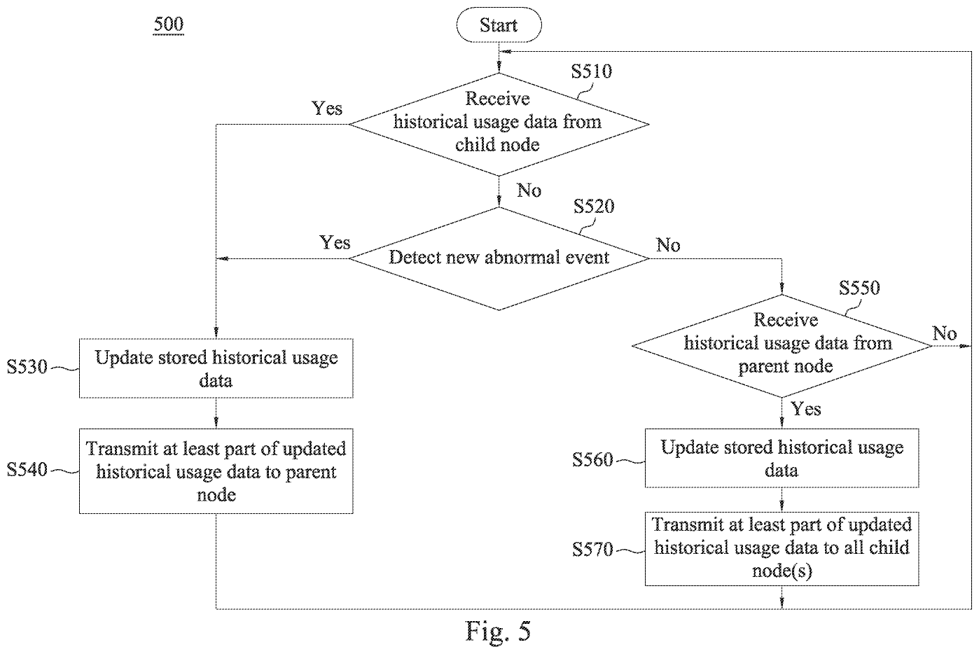

Then, the processor 140 may perform operation S440 to control the communication circuit 150 to transmit at least part of the updated historical usage data ErD to all child node(s), for example, to the energy storage devices 220a and 220b. As such, the energy storage device 210 (i.e., the root node) can control all first level node(s) to update the historical usage data ErD thereof, which will be discussed in operations S510 and S530 of FIG. 5. In some embodiments, the processor 140 transmits only the added part of the stored historical usage data ErD to all child node(s). In other embodiments, the processor 140 transmits the whole updated historical usage data ErD to all child node(s).

After operation S440 is finished, the processor 140 may repeat operation S410. In some embodiments, in the situation that the energy storage device 210 (i.e., the root node) does not connect to any first level node, the energy storage device 210 may omit some operations (e.g., operation S440).

FIG. 5 is a flowchart of a method 500 for synchronizing the historical usage data ErD, according to one embodiment of the present disclosure. When the processor 140 of any one of the energy storage devices 220a and 220b (i.e., the first level nodes) executes the computer-readable instructions stored in the memory 120, the processor 140 may perform the method 500. In operation S510, the processor 140 determines whether the historical usage data ErD of the child node (i.e., the second level node) is received through the communication circuit 150. If the determination of operation S510 is “NO,” the processor 140 proceeds to operation S520 to determine whether the sensor 110 detects the new abnormal event.

On the other hand, if the determination of operation S510 is “YES,” the processor 140 may perform operation S530 to update the stored historical usage data ErD according to the historical usage data ErD from the child node, in which the means for update are similar to those discussed in operation S430, and therefore detailed descriptions thereof are omitted. In addition, if the determination of operation S520 is “YES,” the processor 140 may also perform operation S530, in order to add the error code corresponding to the new abnormal event to the stored historical usage data ErD.

Then, the processor 140 may perform operation S540 to transmit at least part of the updated historical usage data ErD to the parent node (e.g., the energy storage device 210). After operation S540 is finished, the processor 140 may repeat operation S510. In some embodiments, if the determination of operation S510 is “YES” (i.e., the first level node receives the historical usage data ErD from one of the child nodes), the processor 140 may, after finishes operation S530, transmit at least part of the updated historical usage data ErD to the parent node, and also transmit to the other child nodes (i.e., omit to transmit the updated historical usage data ErD to the child node discussed in operation S510).

On the other hand, if the determination of operation S520 is “NO,” the processor 140 performs operation S550 to determine whether the historical usage data ErD of the parent node is received through the communication circuit 150. If not, the processor 140 may repeat operation S510. If so, the processor 140 may perform operation S560 to update the stored historical usage data ErD according to the historical usage data ErD from the parent node, in which the means for update are similar to those discussed in operation S430, and therefore detailed descriptions thereof are omitted.

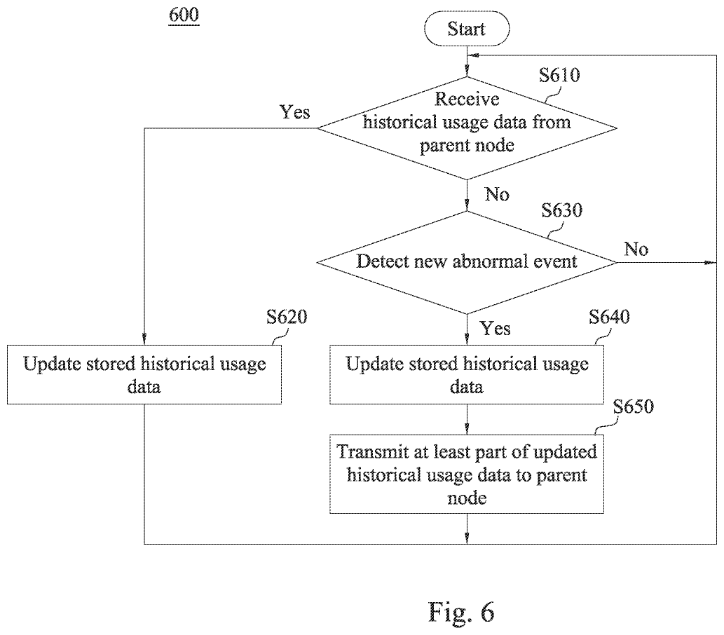

Then, the processor 140 performs operation S570 to transmit at least part of the updated historical usage data ErD to all child node(s). For example, the energy storage device 220b transmits, in operation S570, the updated historical usage data ErD to the energy storage devices 230a-230c. As such, the first level node (e.g., the energy storage device 220b) can control all second level node(s) connected thereto to update the historical usage data ErD, which will be discussed in operations S610 and S630 of FIG. 6. After operation S570 is finished, the processor 140 may repeat operation S510. In the situation that the first level node (e.g., the energy storage device 220a) does not connect to any second level node, the first level node may omit some operations (e.g., operation S570).

In summary, the first level node uses the detection of the new abnormal event or the reception of the historical usage data ErD from other nodes as the trigger event. When the processor 140 of the first level node determines that at least one of the aforementioned trigger events are satisfied, the processor 140 of the first level node updates the historical usage data ErD thereof and transmits the updated historical usage data ErD to other suitable nodes.

FIG. 6 is a flowchart of a method 600 for synchronizing the historical usage data ErD, according to one embodiment of the present disclosure. When the processor 140 of any one of the energy storage devices 230a-230c (i.e., the second level nodes) executes the computer-readable instructions stored in the memory 120, the processor 140 may perform the method 600. In operation S610, the processor 140 determines whether the historical usage data ErD of the parent node (e.g., the energy storage device 220b) is received. If so, the processor 140 performs operation S620 to update the stored historical usage data ErD according to the historical usage data ErD from the parent node, in which the means for update are similar to those discussed in operation S430, and therefore detailed descriptions thereof are omitted. When operation S620 is finished, the processor 140 may repeat operation S610.

On the other hand, when the determination of operation S610 is “NO,” the processor 140 executes operation S630 to determine whether the sensor 110 detects the new abnormal event. If the sensor 110 does not detect the new abnormal event (i.e., the determination of operation S630 is “NO”), the processor 140 may repeat operation S610 and continuously detect the historical usage data ErD from the parent node. Additionally, when the determination of operation S630 is “YES,” the processor 140 performs operation S640 to add the error code corresponding to the new abnormal event to the stored historical usage data ErD. Then, the processor 140 performs operation S650 to control the communication circuit 150 to transmit at least part of the updated historical usage data ErD to the first level node connected thereto. In some embodiments, if the second level node is connected to other nodes (e.g., third level nodes), the processor 140 may also transmit at least part of the updated historical usage data ErD to these connected nodes. After operation S650 is finished, the processor 140 may repeat operation S610. Similar to the root node and the first level node, the second level node uses the detection of the new abnormal event or the reception of the historical usage data ErD from other nodes as the trigger event. When the processor 140 of the second level node determines that at least one of the aforementioned trigger events are satisfied, the processor 140 of the second level node updates the historical usage data ErD thereof and transmits at least part of the updated historical usage data ErD to other nodes.

In some embodiments, if available memory space of any one of the energy storage devices 210, 220a-220b and 230a-230c is exhausted and results that the error code cannot be added to the stored historical usage data ErD, such energy storage device may omit to update the stored historical usage data ErD and omit to transmit the updated historical usage data ErD to other energy storage devices.

In some embodiments, if the available memory space of any one of the energy storage devices 210, 220a-220b and 230a-230c is exhausted, such energy storage device transmits a leave request to the root node of the local area network to request to leave the local area network. After receiving the leave request, the root node evaluates whether to agree the request, and transmits an evaluation result to the energy storage device proposing the leave request.

For example, if the available memory space of the energy storage device 230a is exhausted, the energy storage device 230a transmits the leave request to the energy storage device 220b. The energy storage device 220b exams a destination location in the leave request and transfers the leave request to the energy storage device 210. After receiving the leave request, the energy storage device 210 evaluates an operation situation of the local area network (e.g., currently, whether a number N of the energy storage devices in the local area network approximates to or equals to the maximum number of nodes M, in which N is a positive integer larger than 1 and smaller than or equal to M), and determines whether to agree the energy storage device 230a to leave the local area network. When the current number N of the energy storage devices in the local area network approximates to or equals to the maximum number of nodes M, the energy storage device 210 sends a leave command to the energy storage device 230a through the energy storage device 220b, resulting that the energy storage device 230a leaves the local area network. As a result, a vacant position of the energy storage device 230a allows other energy storage devices to join the local area network. The said “approximate to” may be the situation that N is greater than 80% of M, preferably greater than 90% of M, and more preferably greater than 95% of M.

In some embodiments, the energy storage device 210 may periodically transmit at least part of the stored historical usage data ErD to all child node(s) to trigger other energy storage devices to update the historical usage data ErD. Or, the energy storage devices 220a-220b and 230a-230c may periodically transmit at least part of the stored historical usage data ErD to the parent node, in order to trigger the energy storage device 210 to control other energy storage devices to update the historical usage data ErD. In short, all nodes may periodically transmit at least part of the respective historical usage data ErD to corresponding node(s) connected thereto, so as to back up the respective historical usage data ErD. In this embodiment, when every time an energy storage device joins the local area network, the energy storage device 210 set a timestamp of the newly joined energy storage device to be synchronous with the energy storage device 210. As a result, the energy storage device 210 ensures that each of the child nodes transmit the respective historical usage data ErD at the same time.

Comprehensively considering the embodiments of FIGS. 4-6, it can be known that each energy storage device of the system 200, after updating the stored historical usage data ErD, transmits the updated historical usage data ErD to at least one energy storage device adjacent thereto in the local area network (i.e., the two energy storage devices are respectively the parent node and the child node). In specific, the system 200 transmits the historical usage data ErD, which is updated by the energy storage device of a lower level in the local area network, upward to the energy storage device 210 (i.e., the root node), so that the energy storage device 210 updates the historical usage data ErD thereof. Then, by transmitting the historical usage data ErD updated by the energy storage device 210 downward, the energy storage device 210 can control each of the other energy storage devices in the system 200 (i.e., each of the other nodes in the local area network) to update the historical usage data ErD thereof according to the historical usage data ErD updated by the energy storage device 210. As a result, all energy storage devices 210, 220a-220b and 230a-230c of the system 200 have the almost identical historical usage data ErD. Even if one of the energy storage devices is damaged, the historical usage data ErD thereof is still kept in other energy storage devices.

In summary, an administrator of the system 200 can effectively obtain the historical usage data ErD of all energy storage devices 210, 220a-220b and 230a-230c from any one of the energy storage devices in the system 200. For example, when any one of the energy storage devices of the system 200 is moved from the system 200 to a battery swapping station, the energy storage device uploads, through a network of the battery swapping station, the stored historical usage data ErD to a server for the administrator to access. In addition, by synchronizing the historical usage data ErD, the system 200 mitigates a risk of failing to retrieve the historical usage data ErD due to the damage to the energy storage device.

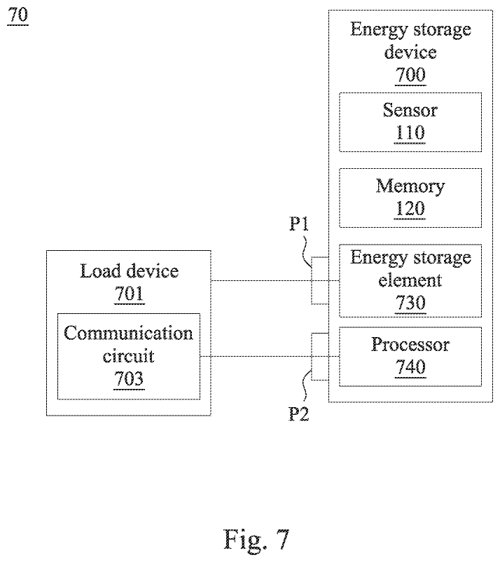

FIG. 7 is a simplified functional block diagram of an electronic system 70 according to one embodiment of the present disclosure. The electronic system 70 comprises at least one energy storage device 700 and a load device 701. Only one energy storage device 700 is depicted in FIG. 7, for the sake of brevity. The load device 701 may be an electric scooter, an electric bike, a battery swapping station, a smart parking meter or an uninterruptible power system (UPS) of a traffic light, but this disclosure is not limited thereto. The energy storage device 700 comprises the sensor 110, the memory 120, an energy storage element 730, and a processor 740, wherein the sensors 110 and the memories 120 of FIGS. 1 and 7 have similar structures, operations and advantages, and therefore detailed descriptions thereof are omitted.

The energy storage element 730 supplies electricity to the load device 701 through an interface P1, and supplies electricity to other functional blocks of the energy storage device 700. In some embodiments, the energy storage element 130 of FIG. 1 and the energy storage element 730 of FIG. 7 have similar structures, operations and advantages, and therefore detailed descriptions thereof are omitted.

The processor 740 is coupled to the communication circuit 703 of the load device 701 through an interface P2. The processor 140 may load and execute the computer-readable instructions in the memory 120 to control the sensor 110, the memory 120, the energy storage element 130 and the communication circuit 703. In some embodiments, the processor 140 of FIG. 1 and the processor 740 of FIG. 7 have similar structures, operations and advantages, and therefore detailed descriptions thereof are omitted.

The energy storage device 700 may be implemented by any one of the energy storage devices 210, 220a-220b and 230a-230c of FIG. 2. Compared with the energy storage device 100, the energy storage device 700 wirelessly communicates with at least one of the electronic system of the local area network through the communication circuit 703 of the load device 701, in which each electronic system comprises the load device 701 and at least one energy storage device 700. When the processor 740 of the energy storage device 700 loads and executes the computer-readable instructions stored in the memory 120, the processor 740 may cooperate with a controller (not shown in the figure) of the load device 701 through the communication circuit 703, so as to cooperatively perform the aforementioned method 400, 500 or 600. For example, when the processor 740 updates the historical usage data ErD in response to any trigger event, the processor 740 transmits the updated historical usage data ErD to the load device 701. Then, the controller of the load device 701 controls the communication circuit 703 to transmit the updated historical usage data ErD to other electronic systems. In other words, the processor 740 is configured to trigger the communication circuit 703 of the load device 701 to transmit the updated historical usage data ErD to other electronic systems.

In specific, in some embodiments, the processor 740 is configured to perform operations S410-S430 of the method 400; configured to perform operations S510, S520, S530, S550 and S560 of the method 500; and configured to perform operations S610-S640 of method 600. The controller of the load device 701 is configured to perform operation S440 of the method 400; configured to perform operations S540 and S570 of the method 500; and configured to perform operation S650 of the method 600.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A system for synchronizing historical usage data of energy storage devices, comprising:
a plurality of energy storage devices, configured to form a plurality of nodes of a local area network by a wireless communication technique, wherein each energy storage device is configured to generate the historical usage data according to an abnormal event occurred in the energy storage device, so as to use the historical usage data to record the abnormal event,
wherein the plurality of nodes comprise a root node, in response to updating, by the root node, the historical usage data of the root node, the root node is configured to control each of the others of the plurality of nodes to update, according to the historical usage data updated by the root node, the historical usage data of each of the others of the plurality of nodes.

2. The system for synchronizing historical usage data of energy storage devices of claim 1, wherein the plurality of nodes comprise at least one first level node, a first level node of the at least one first level node is connected to the root node,
in response to detecting, by the root node, a new abnormal event of the root node, the root node is configured to update the historical usage data of the root node according to the new abnormal event of the root node, and configured to transmit at least part of the historical usage data updated by the root node to the first level node, in order to control the first level node to update the historical usage data of the first level node,
in response to receiving, by the root node, the historical usage data of the first level node, the root node is configured to update, according to the historical usage data of the first level node, the historical usage data of the root node, and configured to transmit the at least part of the historical usage data updated by the root node to the first level node, in order to control the first level node to update the historical usage data of the first level node.

3. The system for synchronizing historical usage data of energy storage devices of claim 2, wherein the plurality of nodes further comprise at least one second level node, and the first level node is connected between the root node and a second level node of the at least one second level node,
in response to detecting, by the first level node, a new abnormal event of the first level node, the first level node is configured to update the historical usage data of the first level node according to the new abnormal event of the first level node, and configured to transmit at least part of the historical usage data updated by the first level node to the root node,
in response to receiving, by the first level node, the at least part of the historical usage data updated by the root node, the first level node is configured to update the historical usage data of the first level node according to the at least part of the historical usage data updated by the root node, and configured to transmit the at least part of the historical usage data updated by the first level node to the second level node,
in response to receiving, by the first level node, the historical usage data of the second level node, the first level node is configured to update the historical usage data of the first level node according to the historical usage data of the second level node, and configured to transmit the at least part of the historical usage data updated by the first level node to the root node.

4. The system for synchronizing historical usage data of energy storage devices of claim 3, wherein in response to detecting, by the second level node, a new abnormal event of the second level node, the second level node is configured to update the historical usage data of the second level node according to the new abnormal event of the second level node,
the second level node is further configured to transmit at least part of the historical usage data updated by the second level node to the first level node.

5. The system for synchronizing historical usage data of energy storage devices of claim 4, wherein the plurality of nodes periodically transmit at least part of respective historical usage data to respective connected corresponding nodes, in order to back up the respective historical usage data.

6. The system for synchronizing historical usage data of energy storage devices of claim 1, wherein the root node is further configured to determine a maximum number of nodes of the local area network.

7. An energy storage device, comprising:
a sensor, configured to detect an abnormal event occurred in the energy storage device;
a communication circuit, configured to connect to a local area network, wherein the local area network comprises a plurality of nodes formed by the energy storage device and other energy storage devices; and
a processor, configured to generate, according to the abnormal event detected by the sensor, historical usage data recording the abnormal event, and, in response to a trigger event, configured to:
update the historical usage data; and
control the communication circuit to transmit at least part of the historical usage data updated by the energy storage device to at least one energy storage device adjacent to the energy storage device in the local area network .

8. The energy storage device of claim 7, wherein the energy storage device is a root node of the local area network,
in response to the trigger event that a new abnormal event occurred in the energy storage device is detected by the sensor, the processor is further configured to update the historical usage data of the energy storage device according to the new abnormal event, and configured to control the communication circuit to transmit the at least part of the historical usage data updated by the energy storage device to all child node(s) of the energy storage device,
in response to the trigger event that another historical usage data is received from the local area network by the communication circuit, the processor is further configured to update the historical usage data of the energy storage device according to the another historical usage data, and configured to control the communication circuit to transmit the at least part of the historical usage data updated by the energy storage device to all child node(s) of the energy storage device.

9. The energy storage device of claim 8, wherein the processor is further configured to determine a maximum number of nodes of the local area network.

10. The energy storage device of claim 7, wherein the energy storage device is a first level node of the local area network connected between a root node and a second level node,
in response to the trigger event that historical usage data of one of the root node and the second level node is received by the communication circuit, the processor is configured to update the historical usage data of the energy storage device according to the historical usage data of the one of the root node and the second level node, and configured to control the communication circuit to transmit the at least part of the historical usage data updated by the energy storage device to another one of the root node and the second level node.

11. The energy storage device of claim 7, wherein the energy storage device is a first level node of the local area network connected between a root node and a second level node,
in response to the trigger event that a new abnormal event occurred in the energy storage device is detected by the sensor, the processor is further configured to update the historical usage data of the energy storage device according to the new abnormal event, and configured to control the communication circuit to transmit the historical usage data updated by the energy storage device to the root node.

12. The energy storage device of claim 7, wherein the processor is further configured to control the communication circuit to periodically transmit at least part of the historical usage data of the energy storage device to the at least one energy storage device adjacent to the energy storage device.

13. An electronic system, comprising:
a load device, comprising a communication circuit configured to connect to a local area network, wherein the local area network comprises a plurality of nodes formed by the electronic system and other electronic systems; and
an energy storage device, configured to provide electricity to the load device, and comprising:
a sensor, configured to detect an abnormal event occurred in the energy storage device; and
a processor, configured to generate, according to the abnormal event detect by the sensor, historical usage data recording the abnormal event, and, in response to a trigger event, configured to: update the historical usage data; and trigger the communication circuit to transmit at least part of the historical usage data updated by the energy storage device to at least one electronic system adjacent to the electronic system in the local area network.

14. The electronic system of claim 13, wherein the electronic system is a root node of the local area network,
in response to the trigger event that a new abnormal event occurred in the energy storage device is detected by the sensor, the processor is further configured to update the historical usage data of the energy storage device according to the new abnormal event, and configured to trigger the communication circuit to transmit the at least part of the historical usage data updated by the energy storage device to all child node(s) of the electronic system,
in response to the trigger event that another historical usage data is received from the local area network by the communication circuit, the processor is further configured to update the historical usage data of the energy storage device according to the another historical usage data, and configured to trigger the communication circuit to transmit the at least part of the historical usage data updated by the energy storage device to all child node(s) of the electronic system.

15. The electronic system of claim 14, wherein the processor is further configured to determine a maximum number of nodes of the local area network.

16. The electronic system of claim 13, wherein the electronic system is a first level node of the local area network connected between a root node and a second level node,
in response to the trigger event that historical usage data of one of the root node and the second level node is received by the communication circuit, the processor is configured to update the historical usage data of the energy storage device according to the historical usage data of the one of the root node and the second level node, and configured to trigger the communication circuit to transmit the at least part of the historical usage data updated by the energy storage device to another one of the root node and the second level node.

17. The electronic system of claim 13, wherein the electronic system is a first level node of the local area network connected between a root node and a second level node,
in response to the trigger event that a new abnormal event occurred in the energy storage device is detected by the sensor, the processor is further configured to update the historical usage data of the energy storage device according to the new abnormal event, and configured to trigger the communication circuit to transmit the historical usage data updated by the energy storage device to the root node.

18. The electronic system of claim 13, wherein the processor is further configured to trigger the communication circuit to periodically transmit at least part of the historical usage data of the energy storage device to the at least one electronic system adjacent to the electronic system.
